(19) United States
(12) Patent Application Publication
(10) Pub. No.: US 2008/0209785 A1
(43) Pub. Date: Sep. 4, 2008

(54) Self-standing collapsible portable structure and method

(75) Inventor: Maya P. Jedlicka, Plano, TX (US)

Correspondence Address: DOCKET CLERK, P.O. DRAWER 800889, DALLAS, TX, 75380, US

(73) Assignee: PACATLANTIC ENTERPRISES, L.L.C., Plano, TX (US)

(21) Appl. No.: 11/999,437

(22) Filed: Dec. 5, 2007

Related U.S. Application Data
(63) Continuation-in-part of application No. 11/496,752, filed on Aug. 1, 2006.
(60) Provisional application No. 60/704,481, filed on Aug. 1, 2005.

(51) Int. Cl. G09F 15/00

(52) U.S. Cl. 40/610

(57) ABSTRACT

A collapsible portable structure employs elongate side panels of a generally triangular shape, each formed by a flexible frame member within a retaining sleeve and fabric within an interior of the frame member. The elongate side panels thus form a pyramidal structure when in a non-collapsed position, the structure having an overall height that is greater than the width of any of the side panels at their widest point. Weights preferably at corner panels between bottom corners of adjacent side panels improve stability for outdoor use. The structure collapses into a substantially cylindrical shape.

### CROSS-REFERENCE TO RELATED APPLICATIONS

The present application claims priority as a continuation-in-part to commonly-assigned, co-pending U.S. patent application Ser. No. 11/496,752 filed on Aug. 1, 2006 and entitled “SELF-STANDING COLLAPSIBLE PORTABLE STRUCTURE AND METHOD,” and through that application claims the benefit of the earlier filing date of U.S. Provisional Patent Application Ser. No. 60/704,481 also entitled “SELF-STANDING COLLAPSIBLE PORTABLE STRUCTURE AND METHOD” and filed Aug. 1, 2005. The content of the above-identified patent documents is hereby incorporated by reference.

### TECHNICAL FIELD

The present disclosure is directed, in general, to self-standing portable structures and, more specifically, to collapsible self-standing portable structures serving as warning markers and the like.

### BACKGROUND

Self-standing portable structures for cautionary, warning or alert purposes have generally taken the form of fixed structures, such as roadway traffic cones, that are bulky and present storage problems even when the structures are capable of nesting. Efforts to develop collapsible self-standing portable structures have resulted in unsatisfactory designs that suffered from several deficiencies. Common drawbacks associated with such designs have included difficulty or complexity in erecting the structures, mechanical component unreliability or failure (particularly in spring-biased designs), and stability of the structure after erection. Such structures also tend to be mechanically complicated, making them expensive to manufacture and troublesome to collapse for storage. In general, the size, weight, complexity and bulkiness—even in a collapsed state—of most self-standing portable structures make them difficult to carry and quickly deploy or to easily collapse and/or conveniently store. Thus, the existing designs of self-standing portable structures used to provide information, such warnings, advertisements, and/or general content, have not been successful in providing a simple structure that is inexpensive to manufacture, compact for storage and transportation, lightweight and easy to carry, quick and easy to erect, and quick and easy to collapse.

There is, therefore, a need in the art for improved collapsible self-standing portable structures.

### SUMMARY

To address the above-discussed deficiencies of the prior art, it is a primary object of the present disclosure to provide, for use in providing a structure to display an alert or warning message, a collapsible portable structure that employs elongate side panels of a generally triangular shape, each formed by a flexible frame member within a retaining sleeve and fabric within an interior of the frame member. The elongate side panels thus form a pyramidal structure when in a non-collapsed position, the structure having an overall height that is greater than the width of any of the side panels at their widest point. Weights preferably at corner panels between bottom corners of adjacent side panels improve stability for outdoor use. The structure collapses into a substantially cylindrical shape.

The foregoing has outlined rather broadly the features and technical advantages of the present disclosure so that those skilled in the art may better understand the detailed description that follows. Additional features and advantages will be described hereinafter that form the subject of the claims. Those skilled in the art will appreciate that they may readily use the conception and the specific embodiment disclosed as a basis for modifying or designing other structures for carrying out the same purposes. Those skilled in the art will also realize that such equivalent constructions do not depart from the spirit and scope of this disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; and the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIGS. 1A, 1B, 1C and 1D are perspective, side, top and bottom views, respectively, of an improved collapsible portable structure according to one embodiment of the present disclosure; and

FIG. 2 is a partial cross-sectional view taken at the side edges of two adjacent panels at section line 2-2 in FIG. 1A.

### DETAILED DESCRIPTION

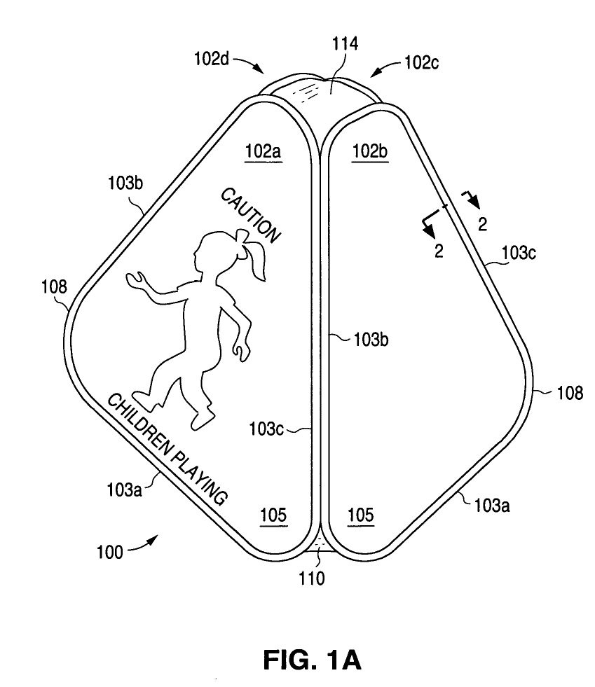

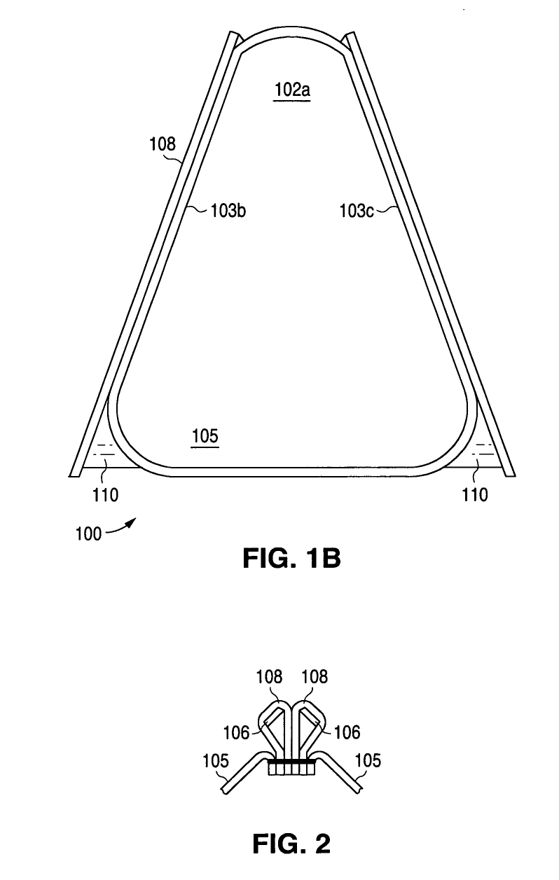

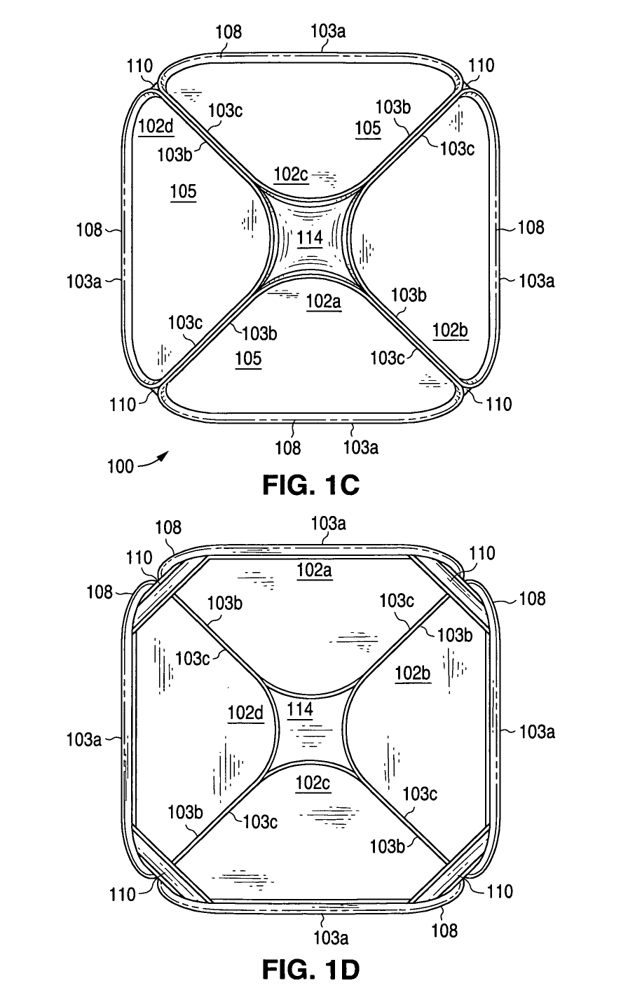

FIGS. 1A through 1D and 2, discussed below, and the various embodiments used to describe the principles of the present invention in this patent document are by way of illustration only and should not be construed in any way to limit the scope of the disclosure. Those skilled in the art will understand that the principles of the present invention may be implemented in any suitably arranged device.

FIG. 1A is a perspective view of an improved collapsible portable structure according to one embodiment of the present disclosure. FIG. 1B is a side (elevation) view of the collapsible portable structure depicted in FIG. 1A; FIG. 1C is a top (plan) view of the collapsible portable structure depicted in FIG. 1A; and FIG. 1D is a bottom view of the collapsible portable structure depicted in FIG. 1A. Collapsible portable structure 100 includes, in the exemplary embodiment, four elongate side panels 102a, 102b, 102c and 102d that are connected or held together. Elongate side panels 102a, which are substantially identical in size and shape in the exemplary embodiment, are generally triangular with rounded corners and each have a bottom edge 103a and two side edges 103b and 103c that are of equal length but longer than the bottom edge 103a. Adjacent pairs of side panels 102a-102b, 102b-102c, 102c-102d and 102a-102d are connected or attached along at least a portion of the respective side edges 103b and 103c for those panels. The collapsible portable structure 100, in a non-collapsed or expanded state, is intended to rest generally on the bottom edges 103a of the side panels 102a-102d. The collapsible portable structure 100 in a non-collapsed or expanded state forms a generally pyramidal shape that is truncated (i.e., a pyramid with a flat top).

Collapsible portable structure 100 is configured such that, in an expanded or non-collapsed position, the elongate side panels 102a-102d are connected or held together along the side edges 103b-103c to form an interior space defined by the side panels 102a-102d with an open bottom. Collapsible portable structure 100 is further configured such that in a collapsed position, the collapsible portable structure 100 has a compact generally cylindrical shape that is reduced in size, as shown in the above-identified patent documents. The collapsible portable structure 100 is altered from the expanded or non-collapsed state to the collapsed state in substantially the same manner as described in the above-identified patent documents. That is, the portable structure 100 is collapsed by folding the structure in on itself at one pair of side edges, by pushing in a first edge between two adjacent side panels such that the interior space defined by the side panels 102a-102d in the expanded position is substantially eliminated, and pushed-in edge is proximate to a second edge between two adjacent side panels, where the first and second edges are located diagonally opposite each other when the structure 100 is in the expanded position. Two pairs of “stacked” side panels are thus formed, and those pairs of side panels are then folded together so that a single “stack” of side panels is formed. The stacked side panels are then simultaneously twisted and folded, with one corner of the stacked panels rotated 360° relative to another corner while being folded over and laterally twisted (that is, rotated around) to overlie that other corner, so that all three corner regions of the side panels overlie each other, forming a generally cylindrically-shaped collapsed structure. A retaining strap may hold the collapsed structure in that position. The collapsible portable structure 100 is restored to the expanded or non-collapsed state in essentially the opposite manner from collapsing the structure described above.

Side panels 102a-102d are preferably each formed with a folded piece of fabric around an entire periphery of the respective side panel, where the folded fabric forms a retaining sleeve 108 for holding a flexible frame member 106 therein. Each side panel 102a-102d is preferably formed from a flexible, water-resistant fabric 105 that substantially covers a space defined by the respective frame member 106 and retaining sleeve 108.

FIG. 2 is a partial cross-sectional view taken at the side edges of two adjacent panels at section line 2-2 in FIG. 1A, illustrating the retaining sleeve 108 and frame member 106 for each panel. The retaining sleeves 108 and the edges of the fabric 105 are sewn together to join the adjacent panels along the side edges. Along other portions of the periphery of a side panel, the retaining sleeve 108 and fabric 105 are similarly sewn together, but without being sewn to the retaining sleeve 108 or fabric 105 for an adjacent panel.

Referring back to FIGS. 1A through 1D, in the example depicted, each frame member 106 is biased to expand outwardly and is constrained by the fabric 105 and retaining sleeve 108 to form three long segments connected by curved portions in a generally triangular shape. The fabric 105 and the retaining sleeve 108 may be formed from the same material, although different colors may be used. The fabric 105 is preferably a bright color such as a fluorescent orange, yellow or red. Each panel includes an alert or warning message in a central portion of the fabric 105, including graphics, text or both. The frame member 106 is preferably flat, with a rectangular cross-section, and formed from a flexible, elastic material such as metal or plastic.

Collapsible portable structure 100 may include optional top panel 114 between and interconnecting the top portions of side panels 102a-102d, sewn together with the retaining sleeve 108 and fabric 105 of the side panels as described above for adjacent side panels. Collapsible portable structure 100 may also optionally include corner panels 110 between the side and bottom edges of adjacent side panels, also sewn together with the retaining sleeve 108 and fabric 105 of the side panels as described above for adjacent side panels. Optionally, a flexible retaining strap 112 may be attached to the top portion of one of the side panels for use in holding and retaining collapsible portable structure 100 in the generally-cylindrical shape when in the collapsed state.

As described above, the side panels 102a-102d in the exemplary embodiment of FIGS. 1A through 1D of this disclosure are elongate. Each side panel 102a-102d is thus generally in the shape of an isosceles triangle. In a non-collapsed or expanded state, the portable structure 100 is approximately 24 inches in total height, with side panels 102a-102d that are approximately 20-21 inches in width at their widest point. These dimensions allow a structure 100 to be formed that is tall enough not to be a tripping hazard, but without occupying a completely proportionate area of floor or ground space (as might a structure formed of side panels generally in the shape of equilateral triangles) and while still collapsing into a generally cylindrical shape as described above.

Collapsible portable structure 100 is configured as a portable free-standing sign carrying alert or warning messages. Thus, each side panel 102a-102d includes a central message area portion bearing graphics and text, such as an image of children running and the text “CAUTION: CHILDREN PLAYING.”

Collapsible portable structure 100 is intended for outdoor as well as indoor use. As such, the elongate nature of the structure 100 makes it susceptible to tipping over as a result of weather conditions such as wind or from gusts of air caused by passing vehicles. While a base (determined by the width of the side panels at their widest point) that is wide relative to the overall height of the collapsible portable structure could reduce the possibility of such tipping, using a wider base would require a larger “footprint” (area occupied) for a portable structure having sufficient height not to constitute a tripping hazard. For that reason, collapsible portable structure 100 includes weights attached to the bottom edge(s) of the side panels 102a-102d. The weights are preferably in the form of sand, small shot, or small ball bearings, or some other material that, when enclosed in fabric, allows the fabric and weight material enclosed therein to be folded and/or otherwise deformed. The weights may be sewn intermittently or continuously along the bottom edge 103a of each side panel. Preferably, however, the weights are affixed to corner panels 110, either by being integrally sewn into those corner panels, by being inserted into fabric pockets within the corner panels (to allow removability), etc. Placing the weights at the bottom corners of collapsible portable structure 100 achieves stabilization with less weight than alternative placement of the weights, and also presents a minimal impediment to collapsing the structure. The amount of weight should be selected to prevent tipping of the collapsible portable structure 100 under normal outdoor conditions.

For outdoor use of the collapsible portable structure 100, stake down holes may also be provided near the bottom edge of each of corner panel 110, or a stake-down loop may be affixed to corner panels 110 or to the bottom edge 103a of each side panel. A simple reinforced hole or short fabric loop receiving a metal or plastic stake for assisting in stabilizing the collapsible portable structure 100 and retaining the structure in place may be provided as described. The fabric loop may be sufficiently large to allow use of a weight (e.g., a rock or brick) to assist in holding the portable structure in place. In another alternative, a hole may be provided through the top panel 114 to allow the portable structure 100 to be staked down to the ground (during outdoor use) from the top. In still another alternate, pockets may be provided within the fabric 105 for one or more sides panel 102a-102d—either on the inside or outside of the portable structure—near the bottom edge 103a or as a separate member affixed to the bottom edge 103a (e.g., by two fabric panels of unequal length such that a “tongue” formed by the longer may be sewn into the seam at the bottom edge) in order to allow weights such as rocks or bricks to be inserted therein.

For use outdoors, the top panel may be adapted to allow a light to be suspended therefrom, lighting the side panels of the collapsible portable structure 100 from the interior. Alternatively, a grommet may be included in the top panel to allow insertion of a light, such as a chemically activated disposable light or a small flashing light.

For use outdoors, side panels 102a-102d may each be formed with a mesh fabric (i.e., a loosely woven or plastic fabric that has a large number of closely-spaced holes) around a peripheral portion, with only the central, message-bearing portion comprising a solid fabric. Use of mesh fabric regions in this manner will allow passage of air through the side panels and reduce the likelihood of tipping, particularly if the collapsible portable structure 100 is weighted in the corner panels 110 as described above. In one embodiment, the entire body of each side panel 102a-102d may be formed from a mesh fabric material, with attachment structures such as Velcro provided to retain a detachable fabric message-bearing panel in a central area of each side panel. The use of mesh fabric in at least peripheral portions of the side panels 102a-102d, between the retaining sleeve 108 and a central message-bearing region, will reduce the amount of weight required to stabilize the structure. The top panel 114 may also be formed of the mesh fabric material. Corner panels 110, if formed with pockets for receiving weights or if weights are not used, may also be formed from the same mesh fabric material.

The elongate shape of the collapsible portable structure described, can produce an overall height for the portable structure that is sufficient to avoid having the portable structure constitute a tripping hazard. Weights within or affixed to the corner panels between bottom corners of the side panels provide stabilization without adding undue weight to the overall structure. The weighted bottom and other optional features such as mesh fabric in perimeter portions of each side panel allow the collapsible portable structure to be employed outdoors without risk of movement by normal winds and the like.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

1. A collapsible portable structure comprising:
four elongate, generally triangular panels, each panel attached at side edges thereof to two adjacent panels within the portable structure,
wherein the four panels are adapted to transition between an expanded position in which the four panels form a generally pyramidal structure to a collapsed position in which the four panels form a generally cylindrical structure.

2. The collapsible portable structure of claim 1, wherein each panel comprises:
a flexible frame member extending around a periphery of the panel; and
a resilient material affixed to the frame member and substantially covering a region interior to the frame member,
wherein the frame member and resilient material allow the panel to deform from a substantially planar state when the portable structure is in the expanded position to a substantially cylindrical state when the portable structure is in the collapsed position.

3. The collapsible portable structure of claim 2, wherein the resilient material is fabric.

4. The collapsible portable structure of claim 2, wherein the frame member biases the panel to the substantially planar state.

5. The collapsible portable structure of claim 2, wherein corner regions of the panel in the substantially planar state overlie each other in the substantially cylindrical state.

6. The collapsible portable structure of claim 1, wherein each panel is hingedly attached to the two adjacent panels to allow the four panels to be folded into a generally stacked arrangement during transition of the portable structure between the expanded and collapsed positions.

7. The collapsible portable structure of claim 6, wherein the four panels are shifted from the generally stacked arrangement into the substantially cylindrical state by concurrently twisting and rotating corner regions of the panels relative to other corner regions of the panels.

8. The collapsible portable structure of claim 1, wherein each panel includes a central message-bearing region containing text, graphics or both.

9. The collapsible portable structure of claim 1, wherein an overall height of the portable structure is greater than a width of the panels at their widest points.

10. A collapsible portable structure comprising:
four elongate, generally triangular panels, each panel including:
a flexible frame member extending around a periphery of the panel; and
a resilient material affixed to the frame member and substantially covering a region interior to the frame member,
wherein each panel is hingedly attached at side edges thereof to two adjacent panels within the portable structure,
wherein the four panels are adapted to transition between an expanded position in which the four panels form a generally pyramidal structure to a collapsed position in which the four panels form a generally cylindrical structure, and
wherein an overall height of the portable structure is greater than a width of the panels at their widest points.

11. The collapsible portable structure of claim 10, wherein the resilient material is fabric.

12. The collapsible portable structure of claim 10, wherein the frame member within each panel biases the panel to the substantially planar state.

13. The collapsible portable structure of claim 10, wherein corner regions of the panel in the substantially planar state overlie each other in the substantially cylindrical state.

14. The collapsible portable structure of claim 10, wherein the four panels are folded into a generally stacked arrangement during transition of the portable structure between the expanded and collapsed positions.

15. The collapsible portable structure of claim 14, wherein the four panels are shifted from the generally stacked arrangement into the substantially cylindrical state by concurrently twisting and rotating corner regions of the panels relative to other corner regions of the panels.

16. The collapsible portable structure of claim 10, wherein each panel includes a central message-bearing region containing text, graphics or both.

17. A collapsible portable structure comprising:
four elongate, generally triangular panels, each panel including:
a flexible frame member extending around a periphery of the panel; and
a resilient material affixed to the frame member and substantially covering a region interior to the frame member,
wherein each panel is hingedly attached at side edges thereof to two adjacent panels within the portable structure; and
corner panels between corners of adjacent panels at bottom edges of the panels, each corner panel including a weighting material or adapted to receive a weight.

18. The collapsible portable structure of claim 17, further comprising:
a top panel between corners of the panels opposite the bottom edges, the top panel adapted to receive a lighting device or a stake.

19. The collapsible portable structure of claim 17, wherein the resilient material comprises a mesh fabric, each panel further comprising a centrally-located message-bearing member containing text, graphics or both.

20. A collapsible structure, comprising:
at least three panels, each panel comprising at least two side edges, a foldable frame member having a folded and an unfolded orientation, and a fabric covering portions of each frame member to form the panel for each frame member when the frame member is in the unfolded orientation, wherein the panels are connected to each other along their side edges to form a ring of panels that enclose a space;
an image provided on the fabric of at least one of the panels; and
a weight coupled to at least one of the panels.
